(19) United States
(12) Patent Application Publication
(10) Pub. No.: US 2015/0064941 A1
(43) Pub. Date: Mar. 5, 2015

(54) IC SOCKET AND CONNECTION TERMINAL

(71) Applicant: FUJITSU LIMITED, Kanagawa-shi (JP)

(72) Inventor: Koji ISHIKAWA, Yokohama (JP)

(21) Appl. No.: 14/332,911

(22) Filed: Jul. 16, 2014

(30) Foreign Application Priority Data
Aug. 30, 2013 (JP) 2013-179689

(51) Int. Cl. H01R 12/71

(52) U.S. Cl. CPC H01R 12/712
USPC 439/68

(57) ABSTRACT

An IC socket includes: a socket main body having a flat plate section in which a plurality of through holes are provided; and a first connection terminal and a second connection terminal that are provided with the through holes of the socket main body, and protrude from an upper side and a lower side of the flat plate section, wherein a capacitor is provided within the first connection terminal.

### CROSS-REFERENCE TO RELATED APPLICATION

This application is based upon and claims the benefit of priority of the prior Japanese Patent Application No. 2013-179689, filed on Aug. 30, 2013, the entire contents of which are incorporated herein by reference.

### FIELD

The embodiments discussed herein relate to an IC socket and a connection terminal.

### BACKGROUND

Semiconductor devices (large scale integrations: LSIs) used in computers and so forth are often mounted on wiring boards via IC sockets.

However, the development of information devices such as computers in recent years has been remarkable, and the transmission speed of signals transmitted between wiring boards and LSIs has increased considerably. In the future, when a further increase in the speed of signals is achieved, signal waveform disturbance due to stubs will become a problem.

Japanese Unexamined Utility Model Registration Application Publication No. 03-130172 and Japanese Laid-open Patent Publication No. 2008-41930 are examples of related art.

### SUMMARY

According to an aspect of the embodiments, an IC socket includes: a socket main body having a flat plate section in which a plurality of through holes are provided; and a first connection terminal and a second connection terminal that are provided with the through holes of the socket main body, and protrude from an upper side and a lower side of the flat plate section, wherein a capacitor is provided within the first connection terminal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic drawing depicting an example of a method for mounting a semiconductor device (LSI) on a wiring board;

FIG. 2 is a schematic drawing in which the portion indicated by reference numeral II in FIG. 1 is enlarged and depicted;

FIG. 3A is a schematic drawing of an IC socket according to an embodiment, and FIG. 3B is likewise a top view of that IC socket;

FIG. 4 is a schematic drawing depicting a method for mounting a semiconductor device on a wiring board in which an IC socket according to an embodiment is used;

FIG. 5A is a longitudinal sectional view of a conductive column, and FIG. 5B is a longitudinal sectional view of a capacitor built-in column;

FIG. 6 is an assembly view of a capacitor built-in column; and

FIGS. 7A and 7B are schematic drawings depicting the relationship between the length of a chip capacitor in a capacitor built-in column and the thickness of a wiring board.

### DESCRIPTION OF EMBODIMENT

Hereinafter, preliminary matters for facilitating understanding of the embodiment are described prior to describing an embodiment.

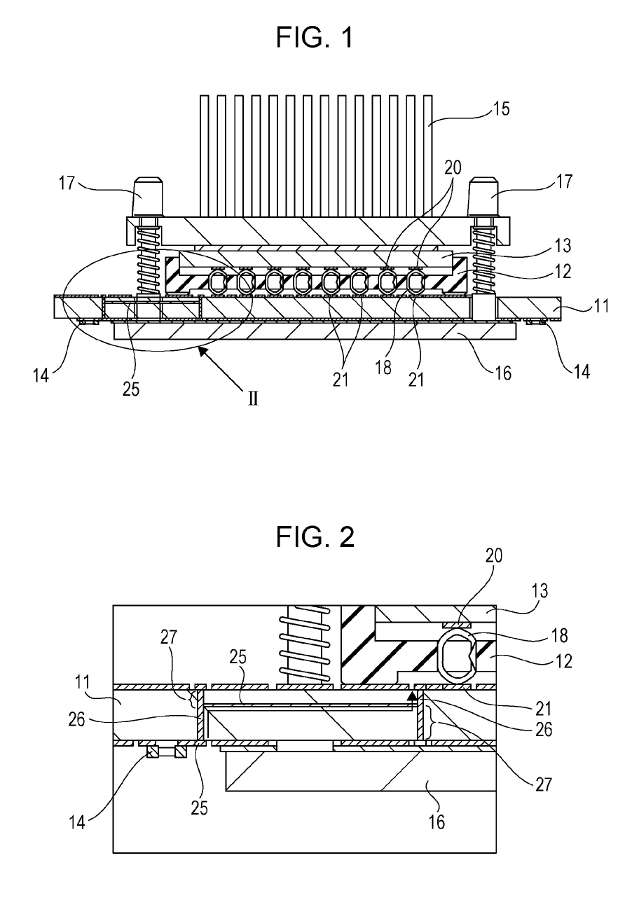

FIG. 1 is a schematic drawing depicting an example of a method for mounting a semiconductor device (LSI) on a wiring board, and FIG. 2 is a schematic drawing in which the portion indicated by reference numeral II in FIG. 1 is enlarged and depicted.

An IC socket 12 is mounted on a wiring board 11, and a semiconductor device 13 is arranged on the IC socket 12. A large number of contact pins 18 are arranged in the IC socket 12, and electrodes 20 of the semiconductor device 13 and electrodes 21 of the wiring board 11 are electrically connected via those contact pins 18.

The semiconductor device 13 generates heat when operating. Therefore, cooling fins 15 that radiate heat generated by the semiconductor device 13 into air are arranged on the semiconductor device 13.

A reinforcing plate (bolster plate) 16 is arranged below the wiring board 11, and the cooling fins 15 and the reinforcing plate 16 are linked by pressure screws 17. When the pressure screws 17 are turned in the tightening direction, the distance between the cooling fins 15 and the reinforcing plate 16 reduces, and the adhesion between the cooling fins 15 and the semiconductor device 13 is ensured, and also the adhesion between the semiconductor device 13 and the contact pins 18 is ensured.

Furthermore, in the example depicted in FIG. 1, coupling capacitors 14 are mounted around the periphery of the reinforcing plate 16 on the rear surface side of the wiring board 11. These coupling capacitors 14 are connected to the electrodes 21 and the contact pins 18 via internal wiring 25 of the wiring board 11, and vias 26 that pass through the wiring board 11 in the vertical direction.

Incidentally, the portions of the vias 26 provided in the wiring board 11 that branch from the signal transmission path (indicated by the arrow mark in FIG. 2) are referred to as stubs. The portions indicated by reference numeral 27 in FIG. 2 are stubs.

The stubs are not a problem when the signal transmission speed is low. However, when the signal transmission speed increases to 15 Gbps to 20 Gbps for example, signals reflected by the stubs interfere with signals passing along the signal transmission path and waveform disturbance occurs, which causes electronic devices to malfunction.

It is possible to avoid the signal waveform disturbance caused by the stubs by removing the portions constituting the stubs by drilling for example. However, in that case complex steps such as drilling are desired, which leads to a rise in manufacturing costs.

In the following embodiment, a description is given with regard to an IC socket in which capacitors are built in, and with which it is possible to avoid signal waveform disturbance caused by stubs.

### Embodiment

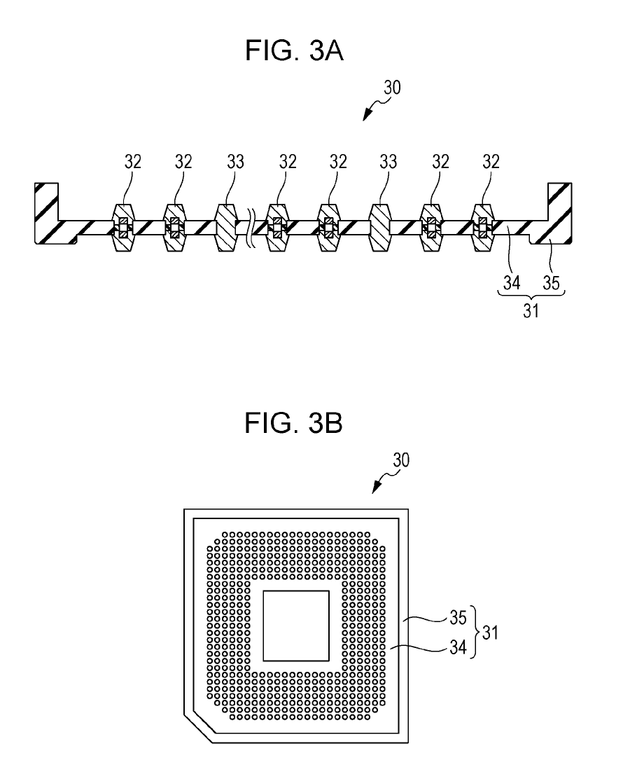

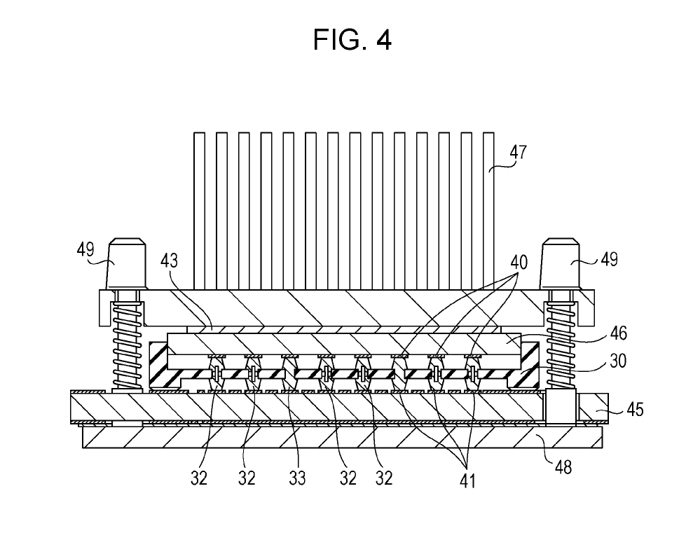

FIG. 3A is a schematic drawing of an IC socket according to an embodiment, and FIG. 3B is likewise a top view of that IC socket. Furthermore, FIG. 4 is a schematic drawing depicting a method for mounting a semiconductor device on a wiring board in which an IC socket according to the embodiment is used. In the present embodiment, a description is given with regard to an example in which an IC socket that connects a semiconductor device (LSI) of a land grid array (LGA) package and a wiring board is applied.

An IC socket 30 according to the present embodiment includes, as depicted in FIG. 3A and FIG. 3B, a socket main body 31, capacitor built-in columns 32, and conductive columns 33. The capacitor built-in columns 32 are examples of a first connection terminal, and the conductive columns 33 are examples of a second connection terminal.

The socket main body 31 is formed from an insulating resin or the like, and includes a flat plate section 34 that has a size corresponding to a semiconductor device 46, and an edge section 35 that is provided around the periphery of the flat plate section 34 and protrudes upwards and downwards.

A plurality of through holes are provided in the flat plate section 34 at locations in alignment with electrodes 40 of the semiconductor device 46, and the capacitor built-in columns 32 and the conductive columns 33 are fitted into those through holes. Both end sections of both the capacitor built-in columns 32 and the conductive columns 33 protrude from the upper side and the lower side of the flat plate section 34.

The semiconductor device 46 is arranged on the IC socket 30 as depicted in FIG. 4, and the electrodes 40 of the semiconductor device 46 and electrodes 41 of a wiring board 45 are electrically connected via the capacitor built-in columns 32 or the conductive columns 33.

Furthermore, cooling fins 47 are arranged on the semiconductor device 46 with heat radiating grease 43 (and/or a thermal conduction sheet) therebetween. These cooling fins 47 are formed from copper or a metal having satisfactory thermal conductivity such as aluminum. A reinforcing plate 48 is arranged below the wiring board 45, and the cooling fins 47 and the reinforcing plate 48 are linked by pressure screws 49.

The lower surface of the edge section 35 of the IC socket 30 comes into contact with the wiring board 45, and a gap is formed between the wiring board 45 and the flat plate section 34 of the IC socket 30 in which protruding sections (head sections 32a and 33a described hereafter) of the capacitor built-in columns 32 and the conductive columns 33 are arranged.

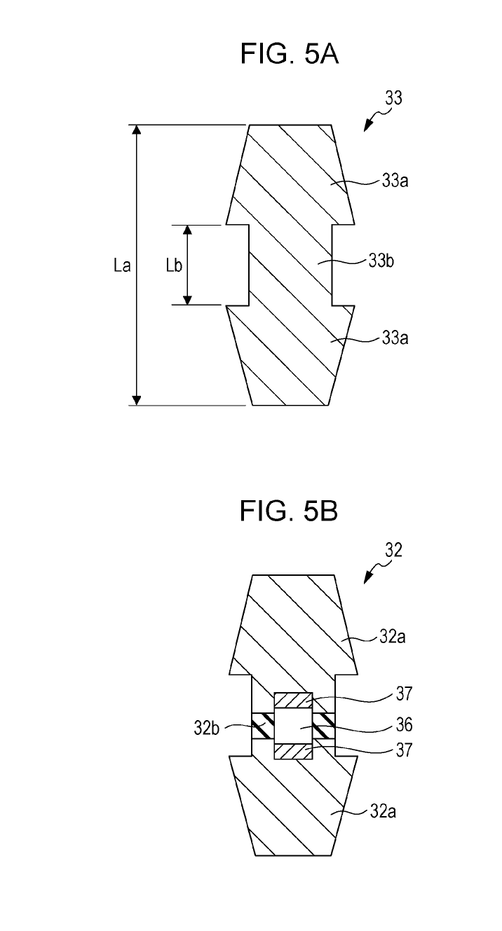

FIG. 5A is a longitudinal sectional view of a conductive column 33, and FIG. 5B is a longitudinal sectional view of a capacitor built-in column 32.

As depicted in FIG. 5A, the conductive column 33 includes a pair of truncated conical head sections 33a arranged in a vertically symmetrical manner, and a cylindrical body section 33b connecting those head sections 33a. Furthermore, the head sections 33a and the body section 33b are integrally formed from a conductive rubber. The length La of the conductive column 33 is approximately 2 mm for example, and the length Lb of the body section 33b is approximately 0.4 mm for example.

The diameter of the body section 33b is set to be approximately the same as the diameter of the through holes provided in the flat plate section 34 of the socket main body 31. Furthermore, the diameter of the base end side (body section 33b side) of the head sections 33a is set to be slightly larger than the diameter of the through holes provided in the flat plate section 34, and the diameter of the tip end side of the head sections 33a is set to be slightly smaller than the diameter of the through holes provided in the flat plate section 34.

As depicted in FIG. 5B, the capacitor built-in column 32 also includes a pair of head sections 32a arranged in a vertically symmetrical manner, and a body section 32b connecting those head sections 32a. The external shape and size of the capacitor built-in column 32 is the same as the conductive column 33; however, a chip capacitor 36 is arranged in the capacitor built-in column 32.

The head sections 32a of the capacitor built-in column 32 are formed from a conductive rubber. One head section 32a is connected to one electrode 37 of the chip capacitor 36, and the other head section 32a is connected to the other electrode 37 of the chip capacitor 36.

Furthermore, the body section 32b is formed from an insulating rubber. The pair of head sections 32a are electrically separated by this body section 32b.

Moreover, the conductive rubber is an example of a resin having elasticity and conductivity. Furthermore, one head section from among the pair of head sections 32a is a first head section, and the other head section is a second head section.

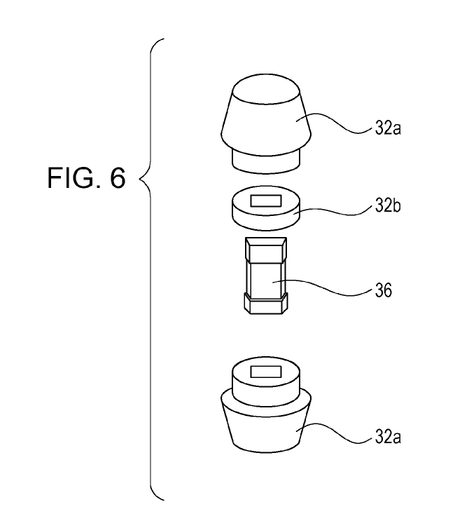

FIG. 6 is an assembly view of a capacitor built-in column 32. As depicted in FIG. 6, it is possible for a capacitor built-in column 32 to be produced by individually manufacturing the head sections 32a and the body section 32b, and attaching those head sections 32a and the body section 32b to the chip capacitor 36.

A capacitor built-in column 32 may be produced by insert-molding the body section 32b after the head sections 32a have been attached to the chip capacitor 36.

Moreover, with regard to the conductive rubber that forms the head sections 32a of the capacitor built-in columns 32 and the conductive columns 33, it is possible to use a rubber obtained by, for example, mixing a carbon or silver (Ag) filler with a natural rubber or a synthetic rubber and imparting conductivity thereto.

Furthermore, it is preferable to coat the electrodes 37 of the chip capacitor 36 with a metal such as silver (Ag) or gold (Au) in order to avoid oxidation due to contact with the head sections 32a and so forth formed from a conductive rubber.

In addition, in order for it to be easy to visually distinguish between the capacitor built-in columns 32 and the conductive columns 33, the color of the head sections 32a of the capacitor built-in columns 32 may be a color that is different from the head sections 33a of the conductive columns 33.

Hereafter, with reference to FIG. 4, a description is given with respect to a method for mounting the semiconductor device 46 on the wiring board 45 by using the IC socket 30 according to the aforementioned embodiment.

First, the capacitor built-in columns 32 and the conductive columns 33 are attached in the through holes provided in the flat plate section 34 of the IC socket 30. At such time, the capacitor built-in columns 32 are attached in places where high-frequency signals pass, and the conductive columns 33 are attached in places where low-frequency signals pass and places that are power source lines.

Since both the capacitor built-in columns 32 and the conductive columns 33 are formed from elastic bodies (rubber), when the head sections 32a and 33a are pushed into the through holes of the IC socket 30, the head sections 32a and 33a elastically deform and pass through the through holes. The head sections 32a and 33a then protrude from the upper side and the lower side of the IC socket 30.

Next, the IC socket 30 is attached at a predetermined location on the wiring board 45. Thereafter, the semiconductor device 46 is arranged on the IC socket 30.

Next, after the heat radiating grease 43 has been applied onto the semiconductor device 46, the cooling fins 47 are arranged on the semiconductor device 46 with the heat radiating grease 43 therebetween. The reinforcing plate 48 is then arranged at the lower side of the wiring board 45, and the cooling fins 47 and the reinforcing plate 48 are linked by the pressure screws 49.

Thereafter, the pressure screws 49 are turned in the tightening direction, and the adhesion between the cooling fins 47 and the semiconductor device 46 is ensured, and also the adhesion between the semiconductor device 46 and the capacitor built-in columns 32 and conductive columns 33 is ensured.

In this way, the mounting of the semiconductor device 46 on the wiring board 45 is completed.

As described above, in the IC socket 30 according to the present embodiment, the capacitor built-in columns 32 are attached in places where high-frequency signals pass, and the conductive columns 33 are attached in other places. It is possible for the chip capacitors 36 provided within the capacitor built-in columns 32 to be used as coupling capacitors or decoupling capacitors for example.

If the chip capacitors 36 provided within the capacitor built-in columns 32 are used as coupling capacitors or decoupling capacitors, coupling capacitors or decoupling capacitors no longer have to be mounted on the wiring board 45. Thus, it is possible to simplify the signal transmission paths of the wiring board 45, and to remove the wiring constituting the stubs. As a result, an effect is demonstrated in that signal waveform disturbance caused by stubs is avoided, and malfunctions of electronic devices are avoided.

Furthermore, since it is possible for the number of capacitors mounted on the wiring board 45 to be reduced by using the IC socket 30 according to the present embodiment, there is also an advantage in that the design of the wiring pattern for the wiring board 45 becomes simpler.

Moreover, since the shape and size of the capacitor built-in columns 32 and the conductive columns 33 are the same in the IC socket 30 according to the present embodiment, it is possible to alter the number and arrangement of the capacitor built-in columns 32 and the conductive columns 33 in accordance with the semiconductor device 46 used.

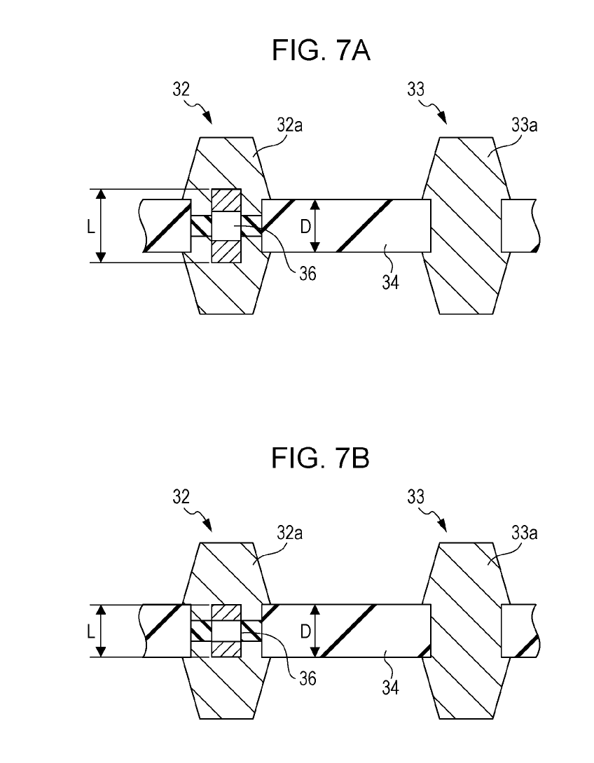

Incidentally, in the example depicted in FIG. 7A, the length L of the chip capacitor 36 within the capacitor built-in column 32 is greater than the thickness D of the wiring board 45, and the upper end and the lower end of the chip capacitor 36 are positioned above or below the upper surface and the lower surface of the wiring board 45. When the upper end and the lower end of the chip capacitor 36 protrude from the upper surface and the lower surface of the wiring board 45 in this manner, the apparent elasticity of the head sections 32a of the capacitor built-in column 32 is lower than the apparent elasticity of the head sections 33a of the conductive column 33.

As a result, the contact pressure between the semiconductor device 46 and the conductive columns 33 is less than the contact pressure between the semiconductor device 46 and the capacitor built-in columns 32, and it is thought that poor contact occurs between the semiconductor device 46 and the conductive columns 33.

In order to avoid this kind of defect, as depicted in FIG. 7B, it is preferable for the length L of the chip capacitor 36 to be equal to or less than the thickness D of the wiring board 45 (L≦D), such that the chip capacitor 36 does not protrude from the surface of the wiring board 45. Thus, the elasticity of the head sections 32a of the capacitor built-in columns 32 is the same as the elasticity of the head sections 33a of the conductive columns 33.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An IC socket, comprising:
a socket main body having a flat plate section in which a plurality of through holes are provided; and
a first connection terminal and a second connection terminal that are provided with the through holes of the socket main body, and protrude from an upper side and a lower side of the flat plate section,
wherein a capacitor is provided within the first connection terminal.

2. The IC socket according to claim 1, wherein
the capacitor has an electrode at both ends in a length direction, and
the first connection terminal comprises
the capacitor,
a first head section that is connected to one electrode of the capacitor and protrudes from the upper side of the flat plate section,
a second head section that is connected to the other electrode of the capacitor and protrudes from the lower side of the flat plate section, and
a body section that is arranged between the first head section and the second head section and electrically separates the first head section and the second head section.

3. The IC socket according to claim 2, wherein
the first head section and the second head section are formed from a resin having elasticity and conductivity.

4. The IC socket according to claim 1, wherein
the second connection terminal is formed from a resin having elasticity and conductivity.

5. The IC socket according to claim 1, wherein
the first connection terminal and the second connection terminal have the same external shape and size.

6. The IC socket according to claim 1, wherein
a length of the capacitor is equal to or less than a thickness of the flat plate section.

7. The IC socket according to claim 2, wherein
gold or silver is coated on a surface of the electrodes of the capacitor.

8. A connection terminal that is provided with a through hole of an IC socket and electrically connects a semiconductor device and a wiring board, the connection terminal comprising:
a first head section that is formed from a resin having elasticity and conductivity and comes into contact with an electrode of the semiconductor device;
a second head section that is formed from a resin having elasticity and conductivity and comes into contact with an electrode of the wiring board;
a capacitor that is arranged between the first head section and the second head section; and
a body section that is formed from an insulating material and is arranged around a periphery of the capacitor.
